(19) United States
(12) Patent Application Publication
(10) Pub. No.: US 2012/0200219 A1
(43) Pub. Date: Aug. 9, 2012

(54) DISPLAY DEVICE USING QUANTUM-DOT AND FABRICATION METHOD THEREOF

(76) Inventor: Jin Won Song, Daejeon (KR)

(21) Appl. No.: 13/503,112

(22) PCT Filed: Oct. 11, 2010
(86) PCT No.: PCT/KR2010/006922

§ 371 Date: Apr. 20, 2012

(30) Foreign Application Priority Data
Oct. 21, 2009 (KR) 10-2009-0100261

(51) Int. Cl. H05B 33/12; H05B 33/10

(52) U.S. Cl. 313/498; 445/24

(57) ABSTRACT

Provided are a display device in which a shape is not limited, the mounting and wiring of elements are not required, visibility, luminance, and the representation of a color are excellent, brightness is adjustable, production cost is low, and fabrication is easy, and a fabrication method thereof. Specifically, the display device includes: a substrate; a light emitting layer formed on the top of the substrate in a predetermined pattern and containing quantum-dots that receives external light to emit light; and a light emitting element providing the external light to the light emitting layer.

### TECHNICAL FIELD

The present invention relates to a display device, and more particularly, to a new electric sign which has a free form and excellent color representation, can control brightness, and has excellent visibility and an excellent promotion effect.

### BACKGROUND ART

Modern indoor and outdoor advertisement boards may be generally classified into advertisement boards by indirect lighting using a fluorescent lamp, an incandescent bulb, tungsten, and the like and advertisement boards by direct lighting using a neon sign, a light emitting element, and the like. These advertisement boards can be installed only in a limited location due to sizes, weights, and the like and serve as a big factor which hinders urban aesthetics, and the like.

The advertisement boards by indirect lighting are easily fabricated at very low cost to be thus most generally used. An advertisement method through using paints on an organic/inorganic substrate or forming sentences, and the like on a transparent substrate by using etching or printing, and installing a lighting device in the vicinity of a substrate is used.

However, the advertisement boards by the indirect lighting have low recognizability and color representation has a great tendency to depend on the lighting, such that an aesthetic effect and a promotion effect are deteriorated.

As the advertisement boards by the direct lighting, a lot of electric signs representing letters, pictures, or the like have recently been used using a light emitting diode (LED). Heat and power consumption of the advertisement board using the LED, which are generated are small. The advertisement board having excellent visibility and luminance and small and thin sizes can be fabricated.

However, the advertisement board using the LED has disadvantages in that an external voltage is applied to the LED, a plurality of LEDs are connected with each other, mounting for electrical connection and mechanical attachment between a substrate for wiring (i.e., a substrate for a printing wiring circuit), the substrate, and the LED and formation of a metal wire should be performed by individually controlling the externally applied voltage for each of the LEDs, and its own shape is limited as a flat panel type.

The present invention provides a new electric sign that has all advantages of both the advertisement boards by the indirect lighting and the advertisement board by the direct lighting, as a result, its structure is simple, its production cost is low, fabricating is easy, visibility is excellent, aesthetic and promotion effects are excellent, the shape is not limited, and spatial utilization is remarkable.

### DISCLOSURE OF INVENTION

### Technical Problem

An object of the present invention is to provide a display device in which its shape is not limited, the mounting and wiring of elements are not required, visibility, luminance, and color representation are excellent, brightness is controllable, the production cost is low, fabrication is easy, and a fabrication method thereof.

### Solution to Problem

In one general aspect, a display device includes: a substrate; a light emitting layer formed on the top of the substrate in a predetermined pattern and containing quantum-dots that receives external light to emit light; and a light emitting element providing the external light to the light emitting layer.

Colors of the display device may be controlled by emission wavelengths of the quantum-dots contained in the light emitting layer, the light emitting layer may include different quantum-dots generating lights having different wavelengths by the external light, and a color for each position in the display device may be controlled by relative mass ratios for each of positions of the different quantum-dots in the light emitting layer.

The brightness of the display device may be controlled by quantum-dot surface density which is the number of quantum-dots contained in the light emitting layer per unit surface area of the substrate.

The external light may be visible light or ultraviolet (UV) light and particularly, the external light may be the UV light. In this case, the light emitting element generating the external light and providing the external light to the light emitting layer is a UV light emitting diode (LED) is a UV light emitting diode (LED) or a UV lamp.

The light emitting layer may be printed or coated with the quantum-dot ink containing the quantum-dots and the substrate may be a flexible substrate.

The display device may further include: a transparent upper substrate positioned on the top of the light emitting layer; and a transparent filler layer having adhesiveness, which is positioned between the light emitting layer and the upper substrate, and the light emitting element may be positioned on the side of a composite lamination layer of the substrate to the upper substrate.

Particularly, the refractive index of the transparent filler layer laminated on the top of the light emitting layer while covering the light emitting layer in contact with the light emitting layer may be larger than those of the substrate and the upper substrate. This may be to increase the irradiation amount of the external light to the light emitting layer by a difference in refractive index between the transparent filler layer, and the substrate and the upper substrate that are provided on the top and bottom of the light emitting layer.

The display device may further include: a first reflection layer reflecting the external light between the substrate and the light emitting layer; and a second reflection layer reflecting the external light between the transparent filler layer and the upper substrate. Specifically, the second reflection layer may selectively reflect the external light.

The display device may further include an adhesive layer having temporal curability, thermal curability, optical curability, or pressure curability, which is formed on the bottom of the light emitting layer to contact the light emitting layer, and the physical binding force between the light emitting layer and the substrate is increased by the adhesive layer.

The surface of the substrate may be hydrophobicly or hydrophilicly modified or includes a functional group selected from a group constituted by an amine group, an aldehyde group, a hydroxyl group, a thiol group, halogen, and a combination thereof.

The pattern of the light emitting layer may include letters, symbols, signs, images including imageries and shapes, and a combination thereof.

In another general aspect, a fabrication method of a display device includes: a) forming a light emitting layer in a predetermined pattern by applying quantum-dot ink containing quantum-dots which receive external light to emit light onto the top of a substrate; b) forming a transparent upper substrate on the top of the light emitting layer; and c) attaching a light emitting element to the side of a composite lamination layer of the substrate to the upper substrate to provide the external light to the light emitting layer, wherein forming electrical wiring with the light emitting layer or forming an electrode are not performed.

The method may further include, before operation b), forming a transparent filler layer by applying a transparent material having adhesiveness onto the top of the light emitting layer.

The method may further include, before operation a), forming an adhesive layer by applying an adhesive having curability, thermal curability, optical curability, or pressure curability onto the top of the substrate.

The method may further include: forming a first reflection layer reflecting the external light on the top of the substrate before operation a); and forming a second reflection layer reflecting the external light on the top of the light emitting layer before operation b).

### Advantageous Effects of Invention

According to embodiments of the present invention, since the shape of a display device is not limited by configuring a light emitting layer printed or coated on a flexible substrate, 3D representation and spatial utilization are free, since quantum-dots contained in the light emitting layer emit light by irradiating external light, the mounting and wiring of elements are not required, since a pattern including letters, symbols, signs, or an imagery and a shape emits light of itself, visibility and luminance are excellent, since a color is represented by mixing quantum-dots emitting lights having different wavelengths, color purity is high and the representation of the color is very free, since brightness is adjustable by the density of the quantum-dots, and since the display device is configured by printing or coating using quantum-dot ink and a light emitting element generating the external light, production cost is low and fabrication is easy.

### BRIEF DESCRIPTION OF DRAWINGS

The above and other objects, features and advantages of the present invention will become apparent from the following description of preferred embodiments given in conjunction with the accompanying drawings, in which:

FIG. 1 is one example showing a configuration of a display device according to the present invention;

FIG. 2 is another example showing a configuration of a display device according to the present invention;

FIG. 3 is yet another example showing a configuration of a display device according to the present invention;

FIG. 4 is still another example showing a configuration of a display device according to the present invention;

FIG. 5 is one example showing a substrate or a light emitting layer in a configuration of a display device according to the present invention;

FIG. 6 is another example showing a substrate or a light emitting layer in a configuration of a display device according to the present invention;

FIG. 7 is yet another example showing a configuration of a display device according to the present invention;

FIG. 8 is still another example showing a configuration of a display device according to the present invention;

FIG. 9 is one example showing a fabrication method of a display device according to the present invention;

FIG. 10 is another example showing a fabrication method of a display device according to the present invention;

FIG. 11 is yet another example showing a fabrication method of a display device according to the present invention; and

FIG. 12 is still another example showing a fabrication method of a display device according to the present invention.

### DETAILED DESCRIPTION OF MAIN ELEMENTS

100: substrate 200: light emitting layer

300: light emitting element 110: transparent filler layer

120: upper substrate 100(A): surface modified substrate

130: adhesive layer 140: first reflection layer

150: second reflection layer

### MODE FOR THE INVENTION

Hereinafter, a display device and a fabrication method thereof according to the embodiments of the present invention will be described in detail with reference to the accompanying drawings. The accompanying drawings are provided as examples in order to fully transfer the spirit of the present invention to those skilled in the art. Therefore, the present invention is not limited to the accompanying drawings and may be implemented in various forms. Further, throughout the specification, like reference numerals refer like elements.

In this case, unless technological terms and scientific terms are defined, they have meanings understood by those skilled in the art and known functions and configurations which may unnecessarily obscure the scope of the present invention will not be described in the following description and accompanying drawings.

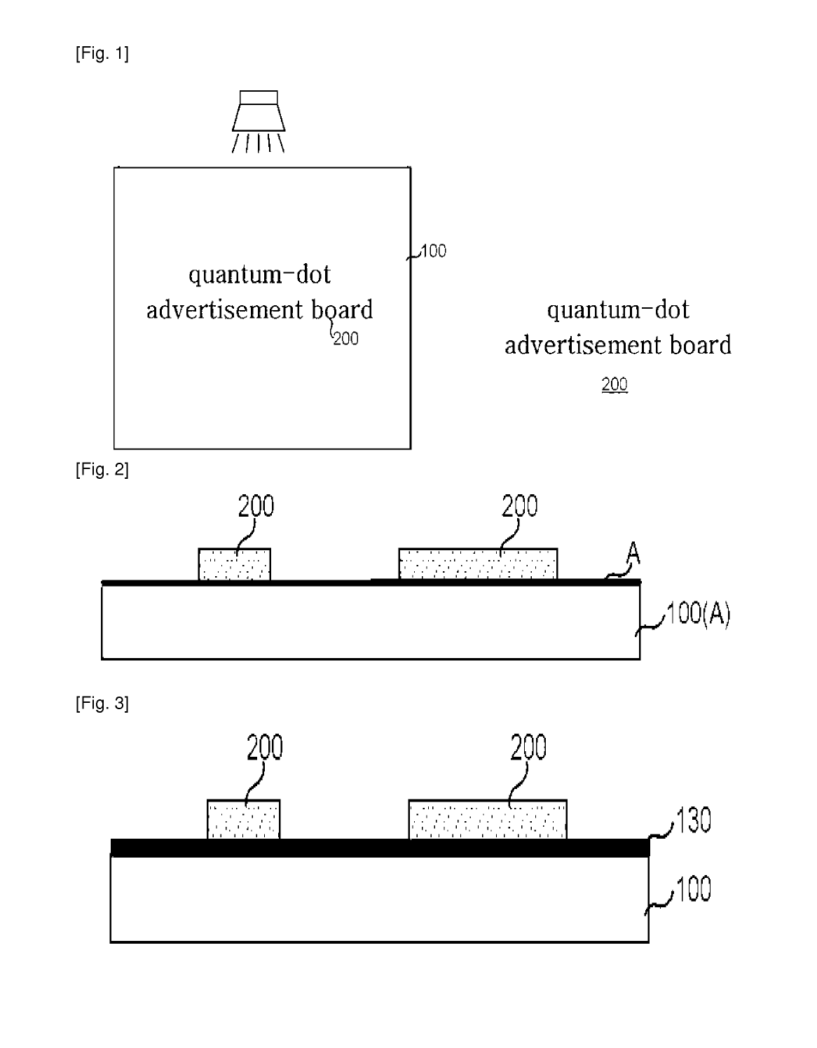

FIG. 1 is one example showing the configuration of a display device according to the present invention. As shown in FIG. 1, the display device includes a substrate 100, a light emitting layer 200 containing a quantum-dot which receives external light to emit light on the top of the substrate and having a predetermined pattern, and a light emitting element 300 generating light and providing external light to the light emitting layer 200.

A pattern displayed by the display device is a pattern of the light emitting layer 200. The pattern of the light emitting layer 200 includes a letter; a symbol; a sign; an image including imagery and shape; or a combination thereof.

In the display device according to the embodiment of the present invention shown as one example of FIG. 1, the quantum-dot which is contained in the light emitting layer 200 receives the external light of the light emitting element 300 to generate light having a predetermined wavelength (emission wavelength) and a color of the display device is controlled by the wavelength which is generated at the quantum-dot.

The light emitting layer 200 contains a single type of quantum-dot which receives the external light and generates light of a single wavelength. The light emitting layer 200 may a single-color light emitting layer. The light emitting layer 200 contains different quantum-dots which receive the external light and generate lights of different wavelengths. The light emitting layer 200 may be a full natural color light emitting layer.

In the case in which the light emitting layer 200 contains different quantum-dots generating lights of different wavelengths, a color for each position in the display device is controlled through the relative mass ratio for each of positions of the different quantum-dots in the light emitting layer 200.

The color for each position in the light emitting layer 200 is controlled by relative mass ratios of quantum-dots of different emission wavelengths, which are contained for each position in the light emitting layer 200. For example, the quantum-dots having different emission wavelengths, which are contained in the light emitting layer 200 are the quantum-dots that emit red (R), green (G), and blue (B). The color for each position is controlled by relative mass ratios of the R, G, and B emitted quantum-dots for each position.

A predetermined pattern is displayed in the display device according to the embodiment of the present invention by the emission in the light emission layer 200 having a predetermined pattern. The brightness of the display device is controlled by quantum-dot surface density which is the number of quantum-dots contained in the light emitting layer 200 per unit surface area of the substrate 100. In this case, the quantum-dot surface density represents the number of all quantum-dots which are provided on the corresponding upper unit surface area per unit surface area of the substrate 100.

The brightness represents the brightness of light emitted by the light emitting layer 200. The light emitting layer 200 emits the light by emission in the quantum-dot. The surface density of the quantum-dots which are contained in the light emitting layer 200 varies, as a result, the brightness for each position in the light emitting layer 200 is controlled. For example, even in the case in which relative mass ratios of quantum-dots which generate different wavelengths are the same as each other, the quantum-dot surface density varies for each position, thereby controlling the brightness of the same color. In this case, while the light emission layer 200 is formed, the quantum-dot surface density may be controlled by using the transparency of the light emitting layer 200 as a control factor. The transparency of the light emitting layer 200 is in the range of 1 to 99%.

More specifically, the quantum-dot surface density is easily controlled through the transparency of the light emitting layer 200 depending on the content of quantum-dots contained in quantum-dot ink at a predetermined position or the thickness of the light emitting layer 200 which varies depending on an application quantity of the quantum-dot ink.

As a result, the thickness of the light emitting layer 200 may be uniform throughout the light emitting layer 200 and may vary depending on the position of the light emitting layer 200. The thickness of the light emitting layer for implementing the transparency in the range of 1 to 99% is in the range of 1 nm to 100 μm.

In the display device according to the embodiment of the present invention based on the FIG. 1, the substrate 100 may be a metallic substrate, an inorganic substrate, or an organic substrate. The substrate 100 may be a transparent substrate or an opaque substrate. The substrate 100 may be a ridge substrate or a flexible substrate.

In the case in which a spatial limitation exists or the display device has not a plane but a curve in terms of an aesthetic aspect, the substrate 100 is preferably a transparent or opaque organic flexible substrate in the display device according to the embodiment of the present invention.

The quantum-dots contained in the light emitting layer 200 include an organic quantum-dot, a semiconductor quantum-dot, a metal oxide quantum-dot, or a metal quantum-dot that receives light, particularly, UV light to generate light having a predetermined wavelength of a visible light region and in addition, include a core-shell structure quantum-dot in which a metallic layer or an inorganic layer is formed the surface of the quantum-dot by using the quantum-dot as a core. Besides, the quantum-dots include a quantum-dot containing impurities for adjusting a band gap.

The light emitting layer 200 is formed by printing or coating with the quantum-dot ink containing the quantum-dots, and specifically, formed by inkjet printing or screen printing with the quantum-dot ink or by gravure coating, bar coating, or spray coating with the quantum-dot ink.

The quantum-dot ink may, of course, further include a viscosity regulator which regulates viscosity used for printing or coating using metallic ink for general wiring, a dispersant for dispersing the quantum-dots, and a binder for strengthening the binding force to the substrate in addition to the quantum-dots and a dispersion medium which disperses the quantum-dots and is removed by volatilization.

As shown in FIG. 2, in the light emitting layer formed by the printing or coating using the quantum-dot ink, the substrate 100 is a surface modified substrate 100A having a modified surface A and the surface modification includes hydrophilic surface modification, hydrophobic surface formation, or modification forming a functional group selected from a group constituted by an amine group, an aldehyde group, a hydroxyl group, a thiol group, halogen, and a combination thereof.

The hydrophobic or hydrophilic modification may form a pattern of the light emitting layer 200 having a distinct boundary line by preventing the applied quantum-dot ink from being dispersed form with the surface modified substrate 100A modified to a hydrophobic surface (hydrophobic modification) or form the light emitting layer 200 of a large-dimension pattern with a short time by facilitating the absorption of the quantum-dot ink applied onto the substrate 100 (hydrophilic modification) in the case in which the quantum-dot ink is water-based ink.

The modification forming the functional group selected from the group constituted by the amine group, the aldehyde group, the hydroxyl group, the thiol group, halogen, and the combination thereof strengthens the binding force between the quantum-dot and the substrate 100 by using a functional group which causes the chemical binding to the quantum-dots contained in the quantum-dot ink.

Further, as shown in FIG. 3, in the light emitting layer formed by the printing or coating using the quantum-dot ink, an adhesive layer 130 is formed on the bottom of the light emitting layer 200 to contact the light emitting layer 200 to strengthen the binding force between the substrate 100 and the light emitting layer 200.

The adhesive layer 130 is the adhesive layer having temporal curability, thermal curability, optical curability, or pressure curability. The temporal curable adhesive means that curing is completed as time elapses by the combination of a curable polymer and a curing agent, the thermal curable adhesive means that the curing is completed by applying heat to a thermal curable polymer, and the optical curable adhesive means that the curing is completed by irradiating light (including UV) to an optical curable polymer.

In this case, the adhesive layer 130 may, of course, further include glass, frit, the viscosity regulator, and the like in addition to the curable polymers.

The light emitting element 300 as an element receiving external current (voltage) and generating external light which is visible light or UV light provides the external light to the quantum-dots contained in the light emitting layer 200. Specifically, the light emitting element 300 includes a light emitting diode (LED), a laser diode (LD), an organic light emitting diode (OLED), a light emitting element by electrical heat emission or a light emitting element by electric discharge, and the like. The light emitting element 300 is provided on the top, bottom, or side of the substrate on the basis of the substrate 100 where the light emitting layer 200 is formed to irradiate the external light to the light emitting layer 200.

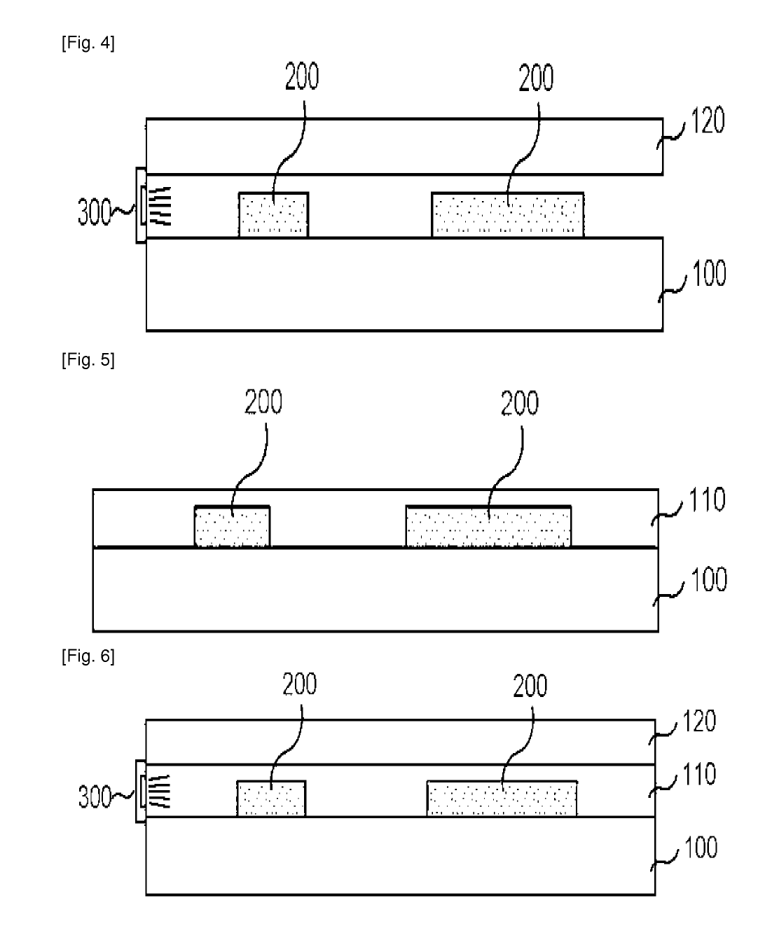

Particularly, the external light is the UV light and the light emitting element 300 generates the UV light and irradiates the UV light to the quantum-dots contained in the light emitting layer 200. In addition, the light emitting element 300 is a UV light emitting diode (LED), or a UV lamp. More particularly, the light emitting element 300 is the UV LED. As shown in FIG. 4, the light emitting element 300 is provided on the side of the substrate 100 where the light emitting layer 200 is formed.

FIG. 4 is another example of a display device according to the present invention. As shown in FIG. 4, the display device according to the embodiment of the present invention further includes an upper substrate 120 which is made of a transparent material. The upper substrate 120 which is made of the transparent material may be an inorganic substrate or an organic substrate. In the case in which the substrate 100 is a flexible substrate, the upper substrate 120 is also preferably the flexible substrate.

In this case, the external light (the external light irradiated by the light emitting element 300) which is irradiated from the side is preferably irradiated to the inside between the substrate 100 and the lower substrate 100 more than the outsides of the substrate 100 and the upper substrate 120 by controlling the refractive index of the substrate 100 and the refractive index of the lower substrate 100.

FIG. 5 is another example of a display device according to the present invention. As shown in FIG. 5, the display device according to the embodiment of the present invention further includes a transparent filler layer 110 formed to fully cover a light emitting layer 200 which is formed on a substrate 100 in a predetermined pattern to preferably physically/chemically protect the light emitting layer 200 and seal it from the outside.

FIG. 6 is another example of a display device according to the present invention. As shown in FIG. 6, the display device according to the embodiment of the present invention further includes the transparent filler layer 110 and the transparent upper substrate 120 specifically described in FIGS. 4 and 5. In addition, the upper substrate 120 is provided on the top of the transparent filler layer 110. The transparent filler layer 110 is preferably is a transparent polymer material having adhesiveness. The upper substrate 120 is preferably physically attached and combined to the substrate 100 where the light emitting layer 200 is formed by the transparent filler layer 110.

In FIG. 6, at least one light emitting element 300 is provided on at least one side of a composite lamination layer of the substrate 100, the light emitting layer 200, the transparent filler layer 110, and the upper substrate 120 to irradiate external light to the light emitting layer 200. In this case, in the composite lamination layer of the substrate 100 to the upper substrate 120 and the light emitting element 300 provided on the side which are described in FIG. 6 or below, the side of the composite lamination layer is appropriately sealed to prevent the external light generated by the light emitting element 300 from being transmitted to the outside of the display device. Further, one example in which the light emitting element 300 is provided on an outer side surface of the composite lamination layer of the substrate 100 to the upper substrate 120 which is described FIG. 6 and below is shown, but the light emitting element 300 may, of course, be provided on the inner side surface of the composite lamination layer.

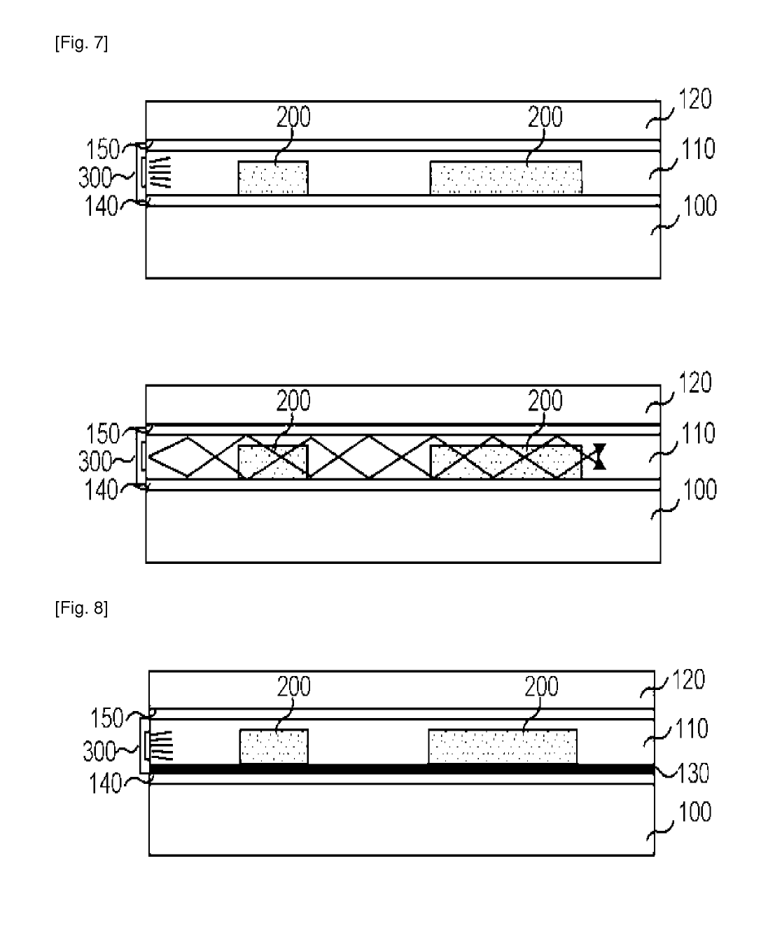

FIG. 7 is another example of a display device according to the present invention. As shown in FIG. 7, the display device according to the embodiment of the present invention further includes a first reflection layer 140 reflecting the external light generated by the light emitting element 300 between the substrate 100 and the light emitting layer 200 and a second reflection layer 150 reflecting the external light generated by the light emitting element 300 between the transparent filler layer 110 and the upper substrate 120 in addition to the substrate 100, the light emitting layer 200, the transparent filler layer 110, and the upper substrate 120.

The first reflection layer 140 and the second reflection layer 150 reflects the external light generated by the light emitting element 300 which is provided on the side of the composite lamination layer of the substrate 100 to the upper substrate 120 to prevent the external light from being transmitted through the substrate 100 to the upper substrate 120 and the second reflection layer 150 allows light generated by the light emitting layer 200 from being transmitted and selectively reflects the external light.

Specifically, the first reflection layer 140 or the second reflection layer 150 as a transparent polymer layer having a refractive index smaller than the transparent filler layer fully reflects the external light irradiated from the side by the difference in refractive index. In this case, all lights emitted from the light emitting element 300 may, of course, be emitted at an angle to satisfy the full-reflection by appropriately shielding a light emission hole of the external light.

More specifically, the first reflection layer 140 or the second reflection layer 150, as the transparent polymer layer having a refractive index smaller than the transparent filler layer and including regular surface unevenesses, fully reflects the external light irradiated from the side by the difference in refractive index and an angle generated by the unevenesses which are formed on the reflection layer (first or second reflection layer).

In the display device, the refractive index of a part including the light emitting layer 200 is larger than that of a part not including the light emitting layer 200, such that more quantity of external light preferably exits in the light emitting layer.

FIG. 8 is another example of a display device according to the present invention. As shown in FIG. 8, the display device according to the embodiment of the present invention further includes the adhesive layer 130, the first reflection layer 140, and the second reflection layer 150. In this case, the adhesive layer 130 serves to improve the adhesive force between the first reflection layer 140 and the light emitting layer 200.

Although the adhesive layer 130 and the first reflection layer 140 are separated from each other in FIG. 8, the adhesive layer 130 may, of course, also serve as the first reflection layer 140 in the case in which the refractive index of the adhesive layer 130 is smaller than that of the transparent filler layer 110 to effectively fully reflect the external light.

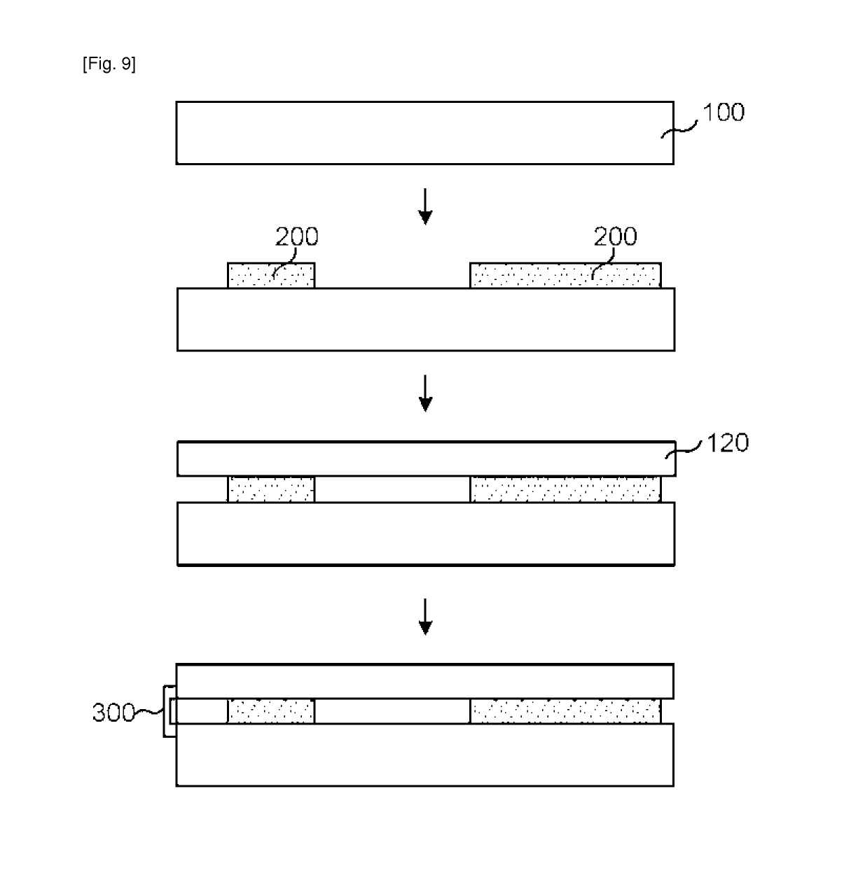

FIG. 9 shows one example of a fabrication method of a display device according to the present invention. Specifically, as shown in FIG. 9, a light emitting layer 200 having a predetermined pattern is formed by applying quantum-dot ink containing quantum-dots onto the top of a substrate 100.

In this case, the quantum-dot ink is applied by printing or coating. The printing includes inkjet printing or screen printing. The coating includes gravure coating, bar coating, or spray coating.

After the light emitting layer 200 is formed, a transparent upper substrate 120 is formed on the top of the light emitting layer and a light emitting element 300 generating external light, preferably, UV light is attached onto the side of a composite lamination layer of the substrate 100, the light emitting layer 200, and the upper substrate 120.

Thereafter, although not shown in the figure, a prevention layer that prevents light from being transmitted may, of course, be provided on the side of the composite lamination layer in order to prevent the external light generated by the light emitting element from being discharged to the outside of the display device through the side of the composite lamination layer.

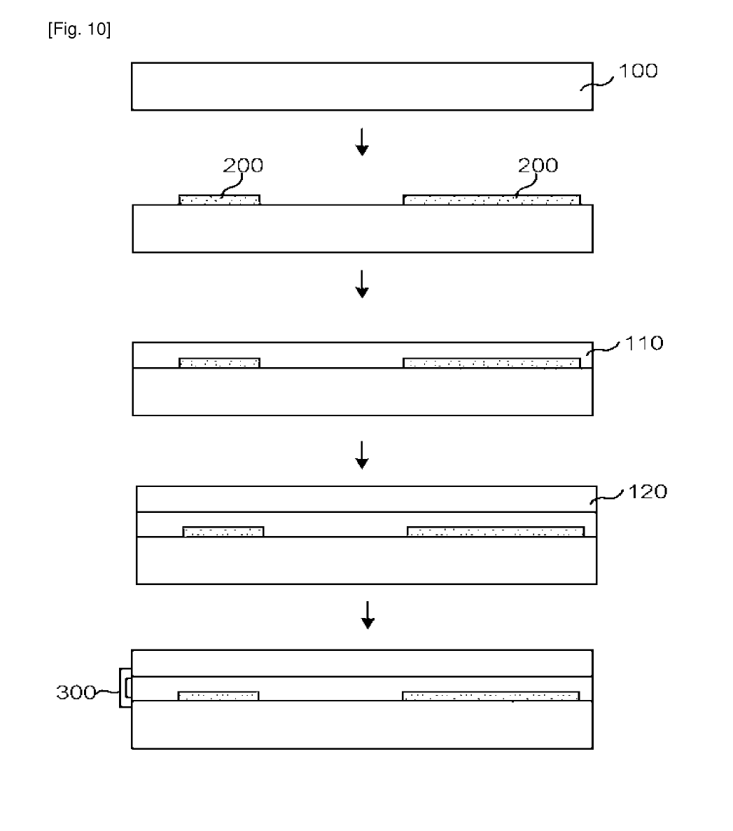

FIG. 10 shows another example of a fabrication method of a display device according to the present invention. Specifically, as shown in FIG. 10, after the light emitting layer 200 is formed on the substrate 100 by using the printing or coating, a transparent adhesive polymer is applied to cover the light emitting layer 200 to form a transparent filler layer 110. The application for forming the transparent filler layer 110 is performed by a spray, doctor blade, meniscus, spin coating, screen printing, stencil printing, or coma roll coating.

After the transparent filler layer 110 is formed, the upper substrate 120 and the light emitting element 300 are formed similarly as FIG. 9. In this case, the upper substrate 120 is physically attached to the substrate 100 where the light emitting layer 200 by the adhesiveness of the transparent filler layer 110.

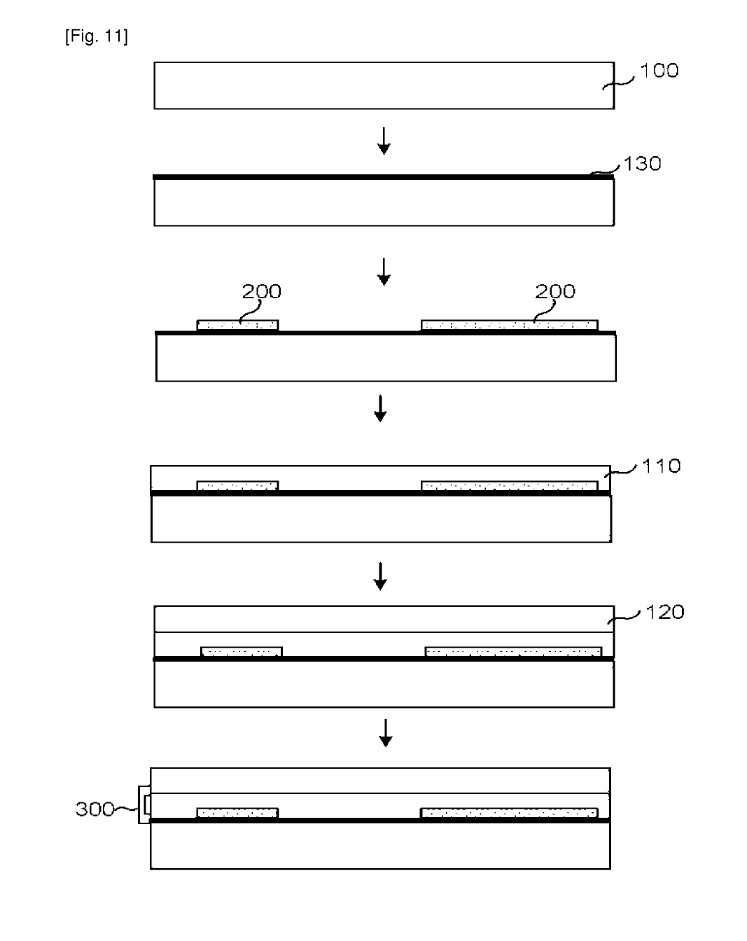

FIG. 11 shows another example of a fabrication method of a display device according to the present invention. Specifically, in a fabrication process based on FIG. 11, an adhesive layer 130 is formed by applying an adhesive material having temporal curability, thermal curability, optical curability, or pressure curability to the substrate 100 before printing or coating the light emitting layer 200 and thereafter, the light emitting layer 200 is printed or coated using the quantum-dot ink. In this case, the application for forming the transparent filler layer 130 is performed by the spray, doctor blade, meniscus, spin coating, screen printing, stencil printing, or coma roll coating.

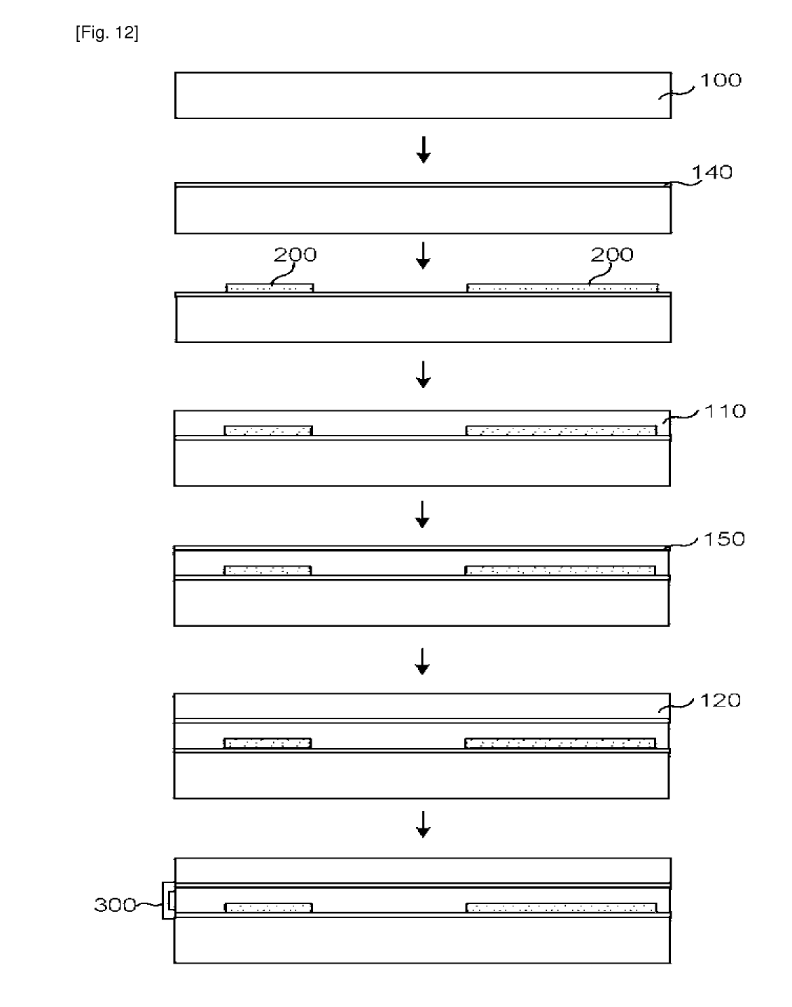

FIG. 12 shows yet another example of a fabrication method of a display device according to the present invention. Specifically, in a fabrication process based on FIG. 12, the first reflection layer 140 is formed on the substrate 100 before printing or coating the light emitting layer 200 and thereafter, the light emitting layer 200 is printed or coated using the quantum-dot ink. In addition, after the transparent filler layer 110 is formed, the second reflection layer 150 is formed on the top of the transparent filler layer 110 and thereafter, the upper substrate 120 is formed.

As described above, according to embodiments of the present invention, since the shape of a display device is not limited by configuring a light emitting layer printed or coated on a flexible substrate, 3D representation and spatial utilization are free, since quantum-dots contained in the light emitting layer emit light by irradiating external light, the mounting and wiring of elements are not required, since a pattern including letters, symbols, signs, or an imagery and a shape emits light of itself, visibility and luminance are excellent, since a color is represented by mixing quantum-dots emitting lights having different wavelengths, color purity is high and the representation of the color is very free, since brightness is adjustable by the density of the quantum-dots, and since the display device is configured by a substrate, printing or coating using quantum-dot ink and a light emitting element generating the external light, production cost is low and fabrication is easy.

While the present invention has bee described in connection with specific matters, and limited embodiments and drawings, it is to be understood that the present invention is not limited to the disclosed embodiments. Various modification and variations are made by those skilled in the art on the basis of the disclosed embodiments.

Accordingly, the spirit of the present invention is not limited to the described embodiments and covers all equivalent arrangements and equivalent modifications to the appended claims in addition to the appended claims.

1. A display device, comprising:
a substrate;
a light emitting layer formed on the top of the substrate in a predetermined pattern and containing quantum-dots that receives external light to emit light; and
a light emitting element providing the external light to the light emitting layer.

2. The device of claim 1, wherein colors of the display device are controlled by emission wavelengths of the quantum-dots contained in the light emitting layer.

3. The device of claim 2, wherein the light emitting layer has different quantum-dots generating lights having different wavelengths by the external light and a color for each position in the display device is controlled by relative mass ratios for each of positions of the different quantum-dots in the light emitting layer.

4. The device of claim 1, wherein the brightness of the display device is controlled by quantum-dot surface density which is the number of quantum-dots contained in the light emitting layer per unit surface area of the substrate.

5. The device of claim 1, wherein the external light is ultraviolet (UV) light.

6. The device of claim 1, wherein the light emitting layer is printed or coated with the quantum-dot ink containing the quantum-dots.

7. The device of claim 1, wherein the substrate is a transparent or opaque metallic substrate, an inorganic substrate, or an organic substrate.

8. The device of claim 1, further comprising:
a transparent upper substrate positioned on the top of the light emitting layer in contact with the light emitting layer; and
a transparent filler layer having adhesiveness, which is positioned between the light emitting layer and the upper substrate,
wherein the light emitting element is positioned on the side of a composite lamination layer of the substrate to the upper substrate.

9. The device of claim 8, wherein the refractive index of the transparent filler layer is larger than those of the substrate and the upper substrate.

10. The device of claim 8, further comprising:
a first reflection layer reflecting the external light between the substrate and the light emitting layer; and
a second reflection layer reflecting the external light between the transparent filler layer and the upper substrate.

11. The device of claim 1, further comprising an adhesive layer having temporal curability, thermal curability, optical curability, or pressure curability, which is formed on the bottom of the light emitting layer to contact the light emitting layer.

12. The device of claim 1, wherein the surface of the substrate is hydrophobicly or hydrophilicly modified or comprises a functional group selected from a group constituted by an amine group, an aldehyde group, a hydroxyl group, a thiol group, halogen, and a combination thereof.

13. The display device of claim 1, wherein the pattern of the light emitting layer includes letters, symbols, signs, images including imageries and shapes, and a combination thereof.

14. A fabrication method of a display device, comprising:
a) forming a light emitting layer in a predetermined pattern by applying quantum-dot ink containing quantum-dots which receive external light to emit light onto the top of a substrate;
b) forming a transparent upper substrate on the top of the light emitting layer; and
c) attaching a light emitting element to the side of a composite lamination layer of the substrate to the upper substrate to provide the external light to the light emitting layer,
wherein forming electrical wiring with the light emitting layer or forming an electrode are not performed.

15. The method of claim 14, further comprising, before operation b), forming a transparent filler layer by applying a transparent material having adhesiveness onto the top of the light emitting layer.

16. The method of claim 14, further comprising, before operation a), forming an adhesive layer by applying an adhesive having curability, thermal curability, optical curability, or pressure curability onto the top of the substrate.

17. The method of claim 14, further comprising:
forming a first reflection layer reflecting the external light on the top of the substrate before operation a); and
forming a second reflection layer reflecting the external light on the top of the light emitting layer before operation b).
